(19) United States
(12) Patent Application Publication
(10) Pub. No.: US 2026/0075448 A1
(43) Pub. Date: Mar. 12, 2026

(54) METHOD AND DEVICE FOR BEAM MANAGEMENT IN COMMUNICATION SYSTEM

(71) Applicant: Electronics and Telecommunications Research Institute, Daejeon (KR)

(72) Inventor: Ji Hyung KIM, Daejeon (KR)

(21) Appl. No.: 19/106,585

(22) PCT Filed: Sep. 19, 2023
(86) PCT No.: PCT/KR2023/013481

§ 371 Date: Feb. 25, 2025

(30) Foreign Application Priority Data
Sep. 29, 2022 (KR) 10-2022-0124498
Aug. 29, 2023 (KR) 10-2023-0114006

(51) Int. Cl. H04W 24/08; H04W 24/02

(52) U.S. Cl. CPC H04W 24/08; H04W 24/02

(57) ABSTRACT

A technique for beam management in a communication system is disclosed. Provided is the method of a terminal, comprising the steps of: receiving reference signals through primary candidate beams from a base station; acquiring measurement information about the reference signals of the primary candidate beams; using an AI/ML model on the basis of the measurement information about the primary candidate beams so as to select secondary candidate beams; and transmitting, to the base station, the information about the selected secondary candidate beams.

### TECHNICAL FIELD

The present disclosure relates to a beam management technique in a communication system, and more particularly, to a beam management technique in a communication system, in which beams are managed using artificial neural network (AI)/machine learning (ML).

### BACKGROUND ART

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g., Long Term Evolution (LTE) communication system or LTE-Advanced (LTE-A) communication system), the 5th generation (5G) communication system (e.g., new radio (NR) communication system) that uses a frequency band (e.g., a frequency band of 6 GHz or above) higher than that of the 4G communication system as well as a frequency band of the 4G communication system (e.g., a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Such communication systems may be designed considering various scenarios, service requirements, potential system compatibility, and/or the like. In particular, discussions on beam-based communication in the 5G NR communication system are active to perform broadband communication in high frequency bands. Accordingly, beam-based communication may be used continuously. Further, communication systems may improve performance using artificial intelligence (AI)/machine learning (ML).

### DISCLOSURE

### Technical Problem

The present disclosure is directed to providing a method and an apparatus for beam management in a communication system, which facilitate beam management using AI/ML techniques.

### Technical Solution

A beam management method in a communication system, according to a first exemplary embodiment of the present disclosure for achieving the above-described objective, may comprise, as a method of a terminal, receiving reference signals from a base station through primary candidate beams; generating measurement information for the reference signals of the primary candidate beams; selecting N secondary candidate beams using an artificial intelligence (AI)/machine learning (ML) model based on the measurement information for the primary candidate beams; and transmitting information on the selected N secondary candidate beams to the base station, wherein N is a positive integer.

The measurement information for the primary candidate beams may include at least one of a reference signal received power (RSRP), a reference signal received quality (RSRQ), a signal to interference-plus-noise ratio (SINR), or a signal noise ratio (SNR) for each of the reference signals of the primary candidate beams.

Each of the reference signals may be one of a synchronization signal block (SSB), a channel state information-reference signal (CSI-RS), or a positioning RS (PRS).

The terminal may perform the selecting of the N secondary candidate beams using the AI/ML model based on the measurement information for the primary candidate beams, by additionally using a location and movement path information of the terminal.

The location and the movement path information of the terminal may include at least one of the location, a trajectory, an angle of arrival (AOA), or an angle of departure (AOD).

The method may further comprise, before the receiving of the reference signals from the base station through the primary candidate beams, receiving reference signals from the base station through beams; obtaining received signal strengths for the reference signals of the beams; selecting the primary candidate beams based on the received signal strengths of the beams; and transmitting information on the selected primary candidate beams to the base station.

The method may further comprise: receiving reference signals from the base station through tertiary candidate beams selected from among the secondary candidate beams; generating measurement information for the reference signals of the tertiary candidate beams; selecting M quaternary candidate beams using the AI/ML model based on the measurement information for the tertiary candidate beams; and transmitting information on the selected M quaternary candidate beams to the base station, wherein M is a positive integer.

The method may further comprise: receiving configuration information on the reference signals for the primary candidate beams from the base station through radio resource control (RRC) signaling, wherein the terminal receives some reference signals using the configuration information in the receiving of the reference signals from the base station through the primary candidate beams.

The configuration information on the reference signals for the primary candidate beams includes a reference signal type and a reference signal periodicity.

The method may further comprise: detecting a beam failure; selecting alternative candidate beams using the AI/ML model based on the measurement information for the primary candidate beams; and transmitting a beam failure report including information on the alternative candidate beams to the base station.

The method may further comprise: receiving information on a resource for the beam failure report from the base station, wherein the terminal transmits the beam failure report including information on the alternative candidate beams to the base station using the resource for the beam failure report.

A beam management method in a communication system, according to a second exemplary embodiment of the present disclosure for achieving the above-described objective, may comprise, as a method of a base station, transmitting reference signals to a terminal through primary candidate beams; receiving information on secondary candidate beams selected by the terminal based on measurement information for the primary candidate beams; selecting tertiary candidate beams using an AI/ML model based on the information on the secondary candidate beams; and transmitting reference signals to the terminal through the tertiary candidate beams.

The base station may perform the selecting of the tertiary candidate beams using the AI/ML model based on the information on the secondary candidate beams, by additionally using at least one of interference information, resource allocation information, or neighboring base station information.

The method may further comprise, before the transmitting of the reference signals to the terminal through the primary candidate beams, transmitting reference signals to the terminal using beams; and receiving, from the terminal, information for the primary candidate beams selected based on received signal strengths of the beams.

The method may further comprise: transmitting information on a resource for a beam failure report to the terminal; and receiving the beam failure report including information on alternative candidate beams from the terminal using the resource for the beam failure report.

The method may further comprise: selecting quaternary candidate beams using the AI/ML model based on information on the alternative candidate beams; and transmitting information on the quaternary candidate beams to the terminal.

A beam management apparatus in a communication system, according to a third exemplary embodiment of the present disclosure for achieving the above-described objective, may comprise, as a terminal, a processor, and the processor may cause the terminal to perform: receiving reference signals from a base station through primary candidate beams; generating measurement information for the reference signals of the primary candidate beams; selecting N secondary candidate beams using an artificial intelligence (AI)/machine learning (ML) model based on the measurement information for the primary candidate beams; and transmitting information on the selected N secondary candidate beams to the base station, wherein N is a positive integer.

The processor may further cause the terminal to perform: before the receiving of the reference signals from the base station through the primary candidate beams, receiving reference signals from the base station through beams; obtaining received signal strengths for the reference signals of the beams; selecting the primary candidate beams based on the received signal strengths of the beams; and transmitting information on the selected primary candidate beams to the base station.

The processor may further cause the terminal to perform: detecting a beam failure; selecting alternative candidate beams using the AI/ML model based on the measurement information for the primary candidate beams; and transmitting a beam failure report including information on the alternative candidate beams to the base station.

The processor may further cause the terminal to perform: receiving information on a resource for the beam failure report from the base station, wherein the terminal transmits the beam failure report including information on the alternative candidate beams to the base station using the resource for the beam failure report.

### Advantageous Effects

According to the present disclosure, methods for managing beams based on AI/ML are provided. In addition, the present disclosure provides methods of configuring a measurement and beam selection period and a beam period using AI/ML. In addition, the present disclosure provides methods of performing a beam failure recovery procedure by utilizing AI/ML functions.

### DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a block diagram illustrating a first exemplary embodiment of a radio access network (RAN) intelligence framework using AI/ML.

FIG. 4 is a conceptual diagram illustrating a first exemplary embodiment of beams used in a communication system.

FIG. 5A is a sequence chart illustrating a first exemplary embodiment of a beam management method in a communication system.

FIG. 5B is a sequence chart illustrating a second exemplary embodiment of a beam management method in a communication system.

FIG. 5C is a sequence chart illustrating a third exemplary embodiment of a beam management method in a communication system.

FIG. 6 is a sequence chart illustrating a fourth exemplary embodiment of a beam management method in a communication system.

FIG. 7A is a sequence chart illustrating a first exemplary embodiment of a beam management method in case of beam failure.

FIG. 7B is a sequence chart illustrating a second exemplary embodiment of a beam management method in case of beam failure.

FIG. 8A is a conceptual diagram illustrating a first exemplary embodiment of a beam management method after beam failure reporting.

FIG. 8B is a conceptual diagram illustrating a second exemplary embodiment of a beam management method after beam failure reporting.

FIG. 9A is a conceptual diagram illustrating a first exemplary embodiment of a signaling method for the T1 period and the T2 period.

FIG. 9B is a conceptual diagram illustrating a second exemplary embodiment of a signaling method for the T1 period and the T2 period.

FIG. 10 is a conceptual diagram illustrating a first exemplary embodiment of a configuration method for the T1 period and the T2 period.

FIG. 11 is a sequence chart illustrating a first exemplary embodiment of a method for establishing an RRC connection between a terminal and a network.

FIG. 12 is a sequence chart illustrating a first exemplary embodiment of a method for transmitting UE capability information.

### MODES OF THE INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

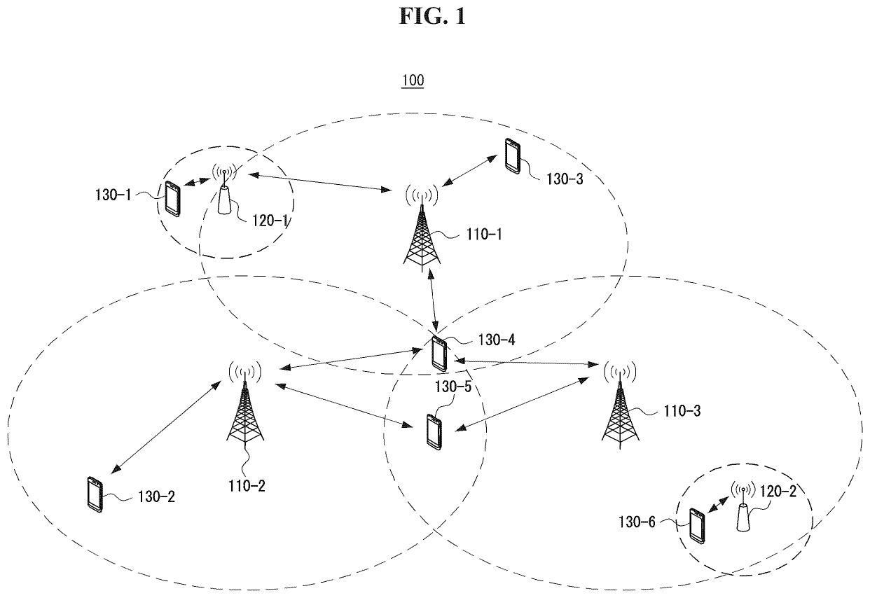

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single-carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have the following structure.

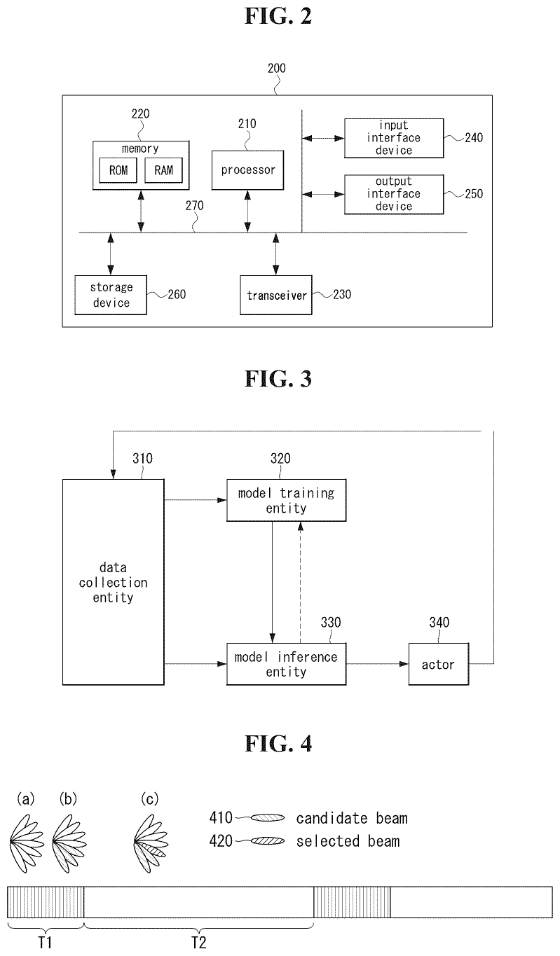

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), relay node, or the like. Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

FIG. 3 is a block diagram illustrating a first exemplary embodiment of a radio access network (RAN) intelligence framework using AI/ML.

Referring to FIG. 3, a communication node may have RAN intelligence including enabled AI/ML algorithms. Here, the AI/ML algorithms may be configured in various forms and may not be limited to a specific form. Hereinafter, the present disclosure will describe an AI/ML-based beam management method according to AI/ML functionality and corresponding inputs and outputs, based on an AI/ML model preconfigured according to the AI/ML algorithm.

A data collection entity 310 may provide input data to a model training entity 320 and a model inference entity 330. As an example, the input data may be at least one of measurement values by another network entity, feedback values by terminals, and feedback values for outputs of the AI/ML model, but it is not limited thereto.

The data collection entity 310 may provide training data to the model training entity 320. Here, the training data may be data provided for an AI/ML model training function. In addition, the data collection entity 310 may provide inference data to the model inference entity 330. Here, the inference data may be data provided for an AI/ML model inference function. The model training entity 320 may be an entity that performs training, validation, and testing of AI/ML models, and may provide performance metrics for the AI/ML models.

The model training entity 320 may provide an AI/ML model to the model inference entity 330. Then, the model inference entity 330 may provide a model performance feedback to the model training entity 320. That is, the model training entity 320 may perform training on the AI/ML model through the feedback from the model inference entity 330. In addition, the model training entity 322 may update the AI/ML model through the model performance feedback from the model inference entity 330. Then, the model training entity 322 may provide an updated AI/ML model to the model inference entity 330. In addition, the model inference entity 330 may receive inference data from the data collection entity 310. Further, the model inference entity 330 may generate outputs using the AI/ML model and provide them to an actor 340. Here, the actor 340 may perform operations according to the outputs. In addition, the actor 340 may provide feedback according to a result of the operation to the data collection entity 310.

That is, the communication node may train and construct the AI/ML model using data for learning (or training) the AI/ML model. The communication node may perform AI/ML model-based operations by using the inference data as inputs to the constructed AI/ML model and generating outputs through the AI/ML model. As a specific example, when the communication node performs AI/ML-based beam management, candidate beam information, measurement information, movement path information, or other information may be input to the model inference entity 330 as the inference data. Then, information on selected beam(s) may be determined as output information and fed back to the AI/ML model. However, this is merely an example and may not be limited thereto, and a specific method of performing beam management using AI/ML of FIG. 3 will be described below.

FIG. 4 is a conceptual diagram illustrating a first exemplary embodiment of beams used in a communication system.

Referring to FIG. 4, (a) of FIG. 4 may illustrate beam set(s) for measurement and each beam set may include a plurality of beams. In addition, a plurality of beam sets for measurement may exist (e.g., a beam set M_A and a beam set M_B). That is, the beam set for measurement may be a set of configurable beams. A terminal and a base station may communicate through the above-described beams. Here, (b) of FIG. 4 may illustrate a candidate beam set for beam selection. The candidate beam set may include candidate beams 410. For example, (b) of FIG. 4 may illustrate a candidate beam set (e.g., beam set B_A) for a T1 period in which beam(s) are selected based on measurement. In the T1 period, for measurement, the base station may transmit reference signals (RSs) through a plurality of candidate beams 410 based on the candidate beam set. The base station and the terminal may determine a selected beam 420 through measurement on the reference signals. (c) of FIG. 4 may illustrate a candidate beam set for beam selection using AI/ML. As an example, (c) of FIG. 4 may illustrate a candidate beam set (e.g., beam set B_B) for a T2 period in which beam(s) are selected based on AI/ML utilization. In the T2 period, the base station and the terminal may determine the selected beam 420 from the candidate beams 410 according to AI/ML. As a more specific example, in the AI/ML model of FIG. 3, the model inference entity may receive information on the candidate beams or other information, derive information on the selected beam, and output it as output information.

That is, the periods may include the T1 period in which beam(s) are selected based on measurement and the T2 period in which beam(s) are selected based on AI/ML. As an example, the base station may transmit reference signals for measurement to the terminal in the T1 period. In this case, the reference signal may be at least one of a synchronization signal block (SSB), a channel state information-reference signal (CSI-RS), or a positioning RS (PRS). As another example, the reference signal may be defined as another reference signal and is not limited to a specific exemplary embodiment. In addition, in the T1 period, the terminal may transmit reference signals for measurement to the base station. In this case, the reference signal may be a sounding reference signal (SRS). As another example, the reference signal may be defined as another reference signal and is not limited to a specific exemplary embodiment.

In addition, the candidate beam set(s) (e.g., beam set M_A) transmitted in the T1 period may include a plurality of candidate beam sets (e.g., beam set M_A1, beam set M_A2 . . .). As another example, a candidate beam set(s) (e.g., beam set M_B) for beam failure recovery management may be different from the candidate beam set(s) (e.g., beam set M_A) described above, and the candidate beam set(s) (e.g., beam set M_B) for beam failure recovery management may also include a plurality of candidate beam sets (e.g., beam set M_B1, beam set M_B2 . . . ).

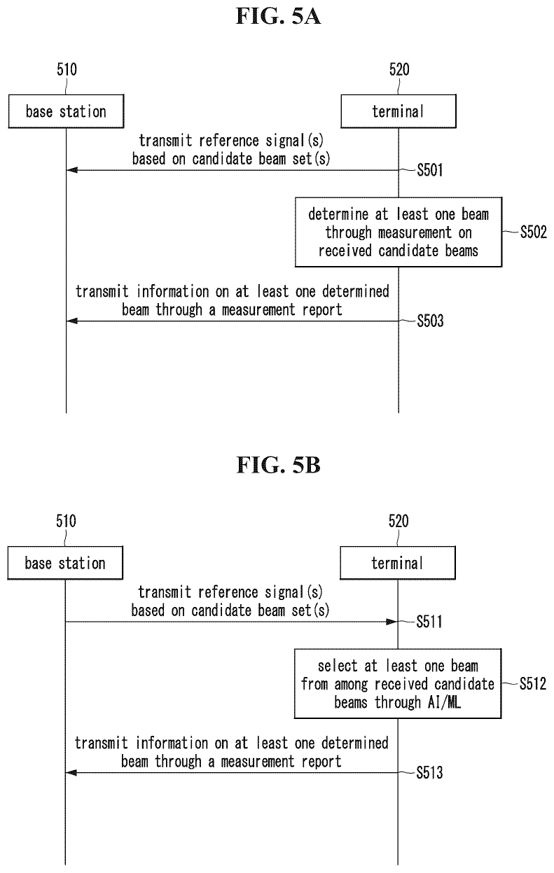

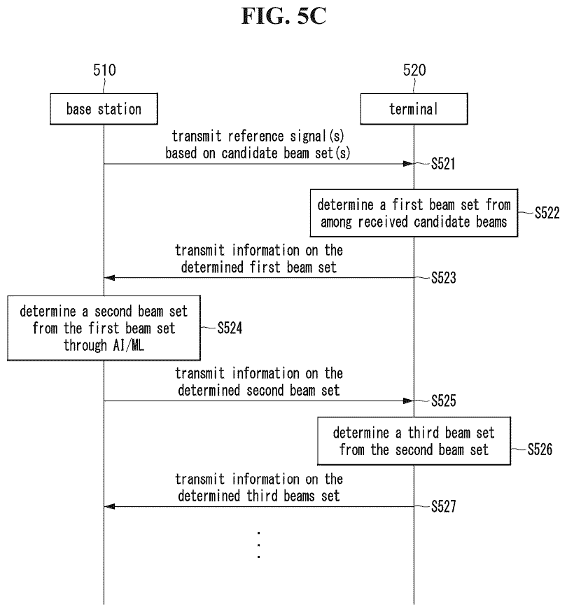

FIG. 5A is a sequence chart illustrating a first exemplary embodiment of a beam management method in a communication system.

Referring to FIG. 5A, a base station 510 may transmit reference signals to a terminal 520 based on a candidate beam set (S501). Here, the reference signal may be at least one of the above-described SSB, CSI-RS, or PRS, and is not limited to a specific exemplary embodiment. The terminal 520 may determine at least one beam by measuring the reference signals transmitted through the candidate beams (S502). More specifically, the terminal 520 may determine N beams in the order of higher reference signal received powers (RSRPs) for the reference signals transmitted from the base station 510 through the candidate beams. Then, the terminal 520 may report information on the N beams to the base station 510 in the order of higher RSRPs (S503). That is, in the T1 period, the terminal 520 may perform measurement based on the candidate beams. In addition, the terminal 520 may transmit information on at least one beam determined to the base station 510 through a measurement report.

FIG. 5B is a sequence chart illustrating a second exemplary embodiment of a beam management method in a communication system.

Referring to FIG. 5B, the base station 510 may transmit reference signals to the terminal 520 based on the candidate beam set (S511). Here, the reference signal may be at least one of the above-described SSB, CSI-RS, or PRS, and is not limited to a specific exemplary embodiment. After performing measurement on the received candidate beams, the terminal 520 may determine at least one beam through an AI/ML model (S512). That is, if the terminal 520 is equipped with an AI/ML model, the terminal 510 may select at least one beam using the AI/ML model.

As a more specific example, the terminal 520 may select N beams using the AI/ML model, and the terminal may report information on the N beams to the base station 510 (S513). That is, the terminal 520 may select the N beams through the AI/ML model, and the terminal may report information on the selected N beams to the base station 510. Here, the AI/ML model may use at least one of measurement information among RSRP, reference signal received quality (RSRQ), signal to interference-plus-noise ratio (SINR), or signal noise ratio (SNR) as input information. In other words, the AI/ML model may use the measurement information as input information.

As another example, the AI/ML model may use information on a location and a movement path of the terminal 520 as input information. As an example, the information on the location and the movement path of the terminal 520 may include at least one of the location, trajectory, angle of arrival (AOA), or angle of departure (AOD). Here, the information on the location and the movement path may be mobility information. That is, the AI/ML model may use at least one of the measurement information or mobility information of the terminal as input information. The terminal 520 may use at least one of the measurement information of the terminal 520 and the mobility information of the terminal 520 as an input to the AI/ML model, and determine and output N beams based thereon. As another example, the terminal or base station may provide inferred result values (i.e., information on selected candidate beam(s), beam failure probability, etc.) as input information for an AI/ML model of a counterpart base station or terminal.

FIG. 5C is a sequence chart illustrating a third exemplary embodiment of a beam management method in a communication system.

Referring to FIG. 5C, the base station 510 may transmit reference signals to the terminal 520 based on the candidate beam set (S521). Here, the reference signal may be at least one of the above-described SSB, CSI-RS, or PRS, and is not limited to a specific exemplary embodiment. The terminal 520 may determine a first beam set consisting of at least one beam by measuring the received candidate beams (S522). More specifically, the terminal 520 may determine N beams as the first beam set in the order of higher RSRPs for the candidate beams transmitted from the base station 510. Then, the terminal 520 may report information on the first beam set consisting of N beams in the order of higher RSRPs to the base station 510 (S523).

Alternatively, the terminal 520 may determine the first beam set consisting of at least one beam through an AI/ML model after performing measurement on the received candidate beams (S522). That is, if the terminal 520 is equipped with an AI/ML model, the terminal 510 may select the first beam set consisting of at least one beam using the AI/ML model. As a more specific example, the terminal 520 may select the first beam set consisting of N beams using the AI/ML model, and the terminal may report information on the first beam set consisting of N beams to the base station 510 (S523).

Meanwhile, the base station may receive the information on the first beam set from the terminal 520. Here, the base station 510 may be a base station equipped with AI/ML functions. As an example, the base station 510 may determine a second beam set consisting of N1 beams among the N beams through the AI/ML model using the information on the N beams (i.e., first beam set) or other information (S524), and the base station 510 may transmit information on the second beam set to the terminal (S525). Then, the terminal 520 may receive the information on the second beam set from the base station.

Here, the other information may include at least one of interference information, resource allocation information, or neighboring base station information, and is not limited to a specific exemplary embodiment. In addition, a set of N1 beams may be the second beam set, and N1 may be a value smaller than N. That is, the base station 510 may select some beams among the N beams and transmit the corresponding information to the terminal 520.

As a more specific example, the base station may use at least one of the information on the N beams (i.e., first beam set) or the other information received from the terminal 520 as input information for the AI/ML model. The base station may include at least one of information on the selected beam(s) or information that may affect beam selection as input information of the AI/ML model without being limited to a specific exemplary embodiment. In this case, output information of the AI/ML model may be information on the N1 beams. Information on N1 beams among N beams may be selected as the output information. That is, the base station may use the AI/ML model to determine the second beam set consisting of fewer beams than the first beam set from the first beam set.

Meanwhile, the terminal 520 may select N2 beams among the N1 beams based on the received information and determine a third beam set consisting of the N2 beams (S526). Here, N2 may be a number smaller than N1, and a set of the N2 beams may be a third beam set. As described above, the terminal 520 may identify information on the second beam set, which is information on the beams determined by the base station 510, and select beams constituting the third beam set based on the information. In this case, the base station 510 may select optimal beam(s) through the above-described scheme. Then, the terminal 520 may report information on the third beam set consisting of N2 beams to the base station 510 (S527). Accordingly, the base station 510 may receive the information on the third beam set from the terminal 520.

In addition, as an example, the above-described operations may be iterated, and the optimal beam(s) may be derived through the iteration. Here, the iteration may be performed based on preconfigured condition(s). As an example, the above-described iteration may be performed until the number of determined beams becomes smaller than a threshold (e.g., Nthreshold). Here, Nthreshold may be a natural number. That is, the base station 510 and the terminal 520 may select the optimal beam(s) by iterating the above-described process. As another example, Nthreshold may be set to 1, and the above-described operation may be iterated until a final beam is selected, and is not limited to the above-described exemplary embodiment. As an example, the above-described iteration may be performed until RSRP values of the determined beam(s) become greater than a certain threshold, and the present disclosure is not limited to the above-described exemplary embodiment.

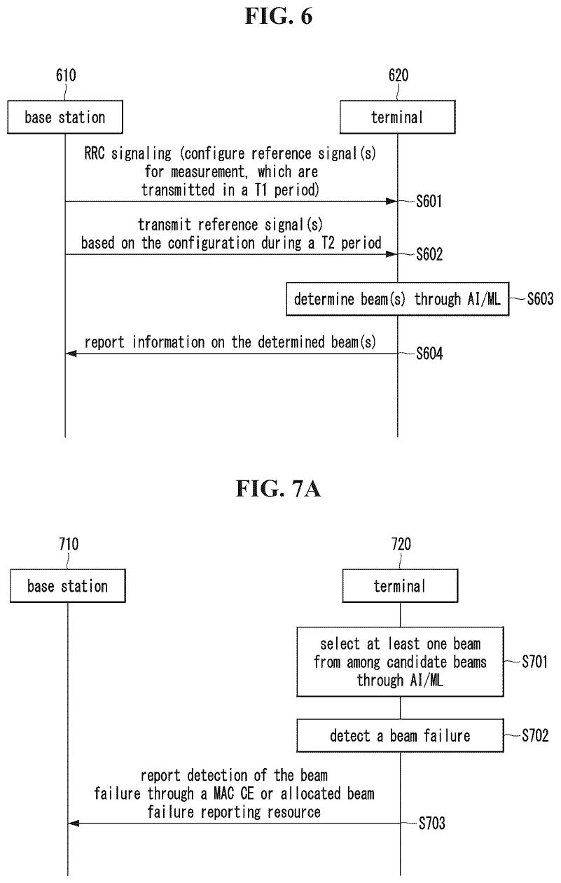

FIG. 6 is a sequence chart illustrating a fourth exemplary embodiment of a beam management method in a communication system.

Referring to FIG. 6, a base station 610 may transmit information on reference signals for measurement, which are to be transmitted during the T2 period, to the terminal 620 through RRC signaling (S601). Then, the terminal 620 may receive information on the reference signals for measurement, which are to be transmitted during the T2 period, from the base station 610 through RRC signaling. Here, the information on the reference signals for measurement may include reference signal type, reference signal periodicity, or other information.

Thereafter, the base station 610 may transmit the reference signals for measurement to the terminal 620 based on the configured information on the reference signals for measurement during the T2 period (S602). Then, the terminal 620 may receive the reference signals for measurement in the T2 period through some of a plurality of beam sets based on the configured information on the reference signals for measurement. Here, some of the plurality of beam sets may be some of the candidate beam set (beam set M_A) and the candidate beam set (beam set M_B) for beam failure recovery management.

As described above, the base station 610 may transmit only some of the reference signals to the terminal 620 in the T2 period through some of the plurality of beam sets. Here, the reference signals for measurement transmitted during the T2 period may be configured to the terminal 620 through RRC signaling. The base station 610 may transmit information on the reference signals that the terminal 620 receives in the T2 period to the terminal 620 through RRC signaling, and based thereon, the base station 610 may transmit the reference signals to the terminal 620 in the T2 period. As a specific example, the reference signal type, reference signal periodicity, or other information transmitted through RRC signaling may be configured to the terminal 620, without being limited to a specific exemplary embodiment. That is, the terminal 620 may receive the reference signals in the T2 period through some of the plurality of beam sets based the information on the reference signal(s) configured by the base station 610.

The terminal 520 may select beams using the AI/ML model (S603), and the terminal may report information on the selected beams to the base station 510 (S604). That is, the terminal 620 may select N beams through the AI/ML model, and the terminal may report information on the selected N beams to the base station 610.

Meanwhile, the terminal 620 may consider a case where the terminal 620 does not receive all reference signals in the T2 period. Here, when the terminal 620 selects specific beam(s) from the candidate beams through the AI/ML model, input information of the AI/ML model may include the mobility information of the terminal or other interference information described above, without being limited thereto.

As another example, the terminal 620 may receive some reference signals configured based on RRC signaling in the T2 period. In this case, the input information of the AI/ML model may include the information on the reference signals in addition to the above-mentioned mobility information or other interference information, and information on selected beams may be derived as output information based thereon. As an example, the terminal 620 may receive only minimum reference signals for beam selection through the AI/ML model without being limited to a specific exemplary embodiment. Then, the terminal 620 may transmit information on the determined beam(s) to the base station 610, and operate in the T2 period as described above.

Meanwhile, the terminal 620 may select beam(s) using the AI/ML model in the T2 period. As an example, the terminal 620 may not receive the reference signals from the base station 610 in the T2 period, and may select beam(s) using the AI/ML model.

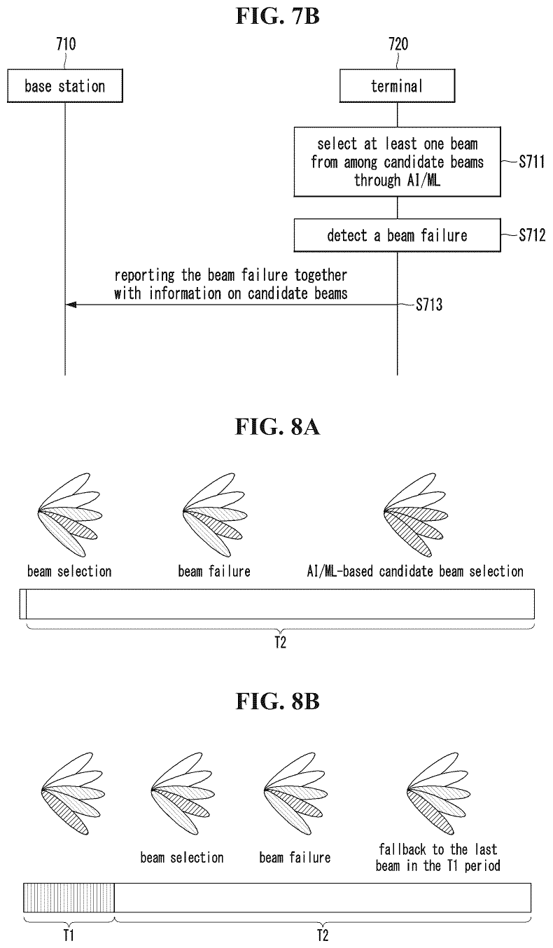

FIG. 7A is a sequence chart illustrating a first exemplary embodiment of a beam management method in case of beam failure.

Referring to FIG. 7A, a terminal 720 may not receive any reference signal from a base station 710 in the T2 period. In the above-described situation, the terminal 720 may select at least one beam from among candidate beams through an AI/ML model. Alternatively, the terminal 720 may receive some reference signals from the base station 710 in the T2 period. In the above-described situation, the terminal 720 may select at least one beam from among the candidate beams through the AI/ML model (S701).

Meanwhile, in the T2 period, the terminal 720 may detect a beam failure (S702). In this case, the terminal 720 may report the beam failure to the base station 710 using a MAC CE or an allocated beam failure reporting resource (S703). That is, the terminal 720 may detect occurrence of a beam failure in the T2 period, report the corresponding information to the base station 710, and perform subsequent operations.

As a specific example, the terminal 720 may report a beam failure to the base station 710 in an event-triggered manner. That is, the terminal 720 may detect an event regarding a beam failure. In this case, the terminal may report the beam failure to the base station 710. As an example, the terminal 720 may report the beam failure to the base station 710 through a MAC CE. As another example, the terminal 720 may detect an event regarding a beam failure. In this case, the terminal 720 may request reference signals for measurement from the base station 710. Then, the terminal 720 may receive the reference signals from the base station 710 and perform measurement or beam selection.

As another example, during the T2 period, the base station 710 may allocate a resource for beam failure reporting to the terminal 720. In this case, if a beam failure occurs, the terminal 720 may report the beam failure to the base station 710 through the resource for beam failure reporting.

FIG. 7B is a sequence chart illustrating a second exemplary embodiment of a beam management method in case of beam failure.

Referring to FIG. 7B, the terminal 720 may detect a beam failure in the T2 period, as described above.

Referring to FIG. 7B, the terminal 720 may not receive any reference signal from the base station 710 in the T2 period. In the above-described situation, the terminal 720 may select at least one beam from among candidate beams through the AI/ML model. Alternatively, the terminal 720 may receive some reference signals from the base station 710 in the T2 period. In the above-described situation, the terminal 720 may select at least one beam from among the candidate beams through the AI/ML model (S711).

Meanwhile, in the T2 period, the terminal 720 may detect a beam failure (S712). In this case, the terminal 720 may report the beam failure to the base station 710 using a MAC CE or an allocated beam failure reporting resource (S713). In this case, the terminal 720 may deliver information on the candidate beam(s) selected utilizing the AI/ML function to the base station 710 together with a beam failure report. Accordingly, the base station 720 may receive the beam failure report including information on the candidate beam(s) selected using the AI/ML function from the terminal 720. Then, the base station 710 may perform subsequent operations by considering information on the candidate beam(s) selected by the terminal 720 through the AI/ML model.

Here, as an example, the base station 710 may recognize the beam failure. In this case, the base station 710 may transmit reference signals for measurement for candidate beam selection to the terminal 720. Then, the terminal 720 may perform measurement based on the reference signals for measurement. In addition, the terminal 720 may select candidate beam(s) based on the reference signals for measurement. The terminal 7200 may report information on the selected candidate beam(s) to the base station 710. The base station 710 may receive the information on the selected candidate beam(s). The base station 710 may determine a new beam based on the information on the selected candidate beam(s).

As another example, the base station 710 may recognize the beam failure. In this case, the base station 710 may directly select a new beam and transmit information on the selected new beam to the terminal 720.

As another example, the base station 710 may recognize the beam failure. In this case, the base station 710 may terminate the T2 period described above. In addition, the base station 710 may indicate the terminal 720 to start a T1 period. That is, the base station 710 may switch the current period to a new period for beam selection based on reference signals for measurement. Then, the base station 710 and the terminal 720 may determine beam(s) based on the switched period.

FIG. 8A is a conceptual diagram illustrating a first exemplary embodiment of a beam management method after beam failure reporting.

Referring to FIG. 8A, a terminal may report a beam failure to a base station. In this case, if the terminal is equipped with an AI/ML function, the terminal may select a candidate beam based on the AI/ML function as a beam to be used, before receiving a response from the base station. Here, the candidate beam may be a wide beam. The terminal may communicate with the base station 810 through the candidate beam. Thereafter, the terminal 820 may select a new beam based on a response of the base station 810, as described above.

FIG. 8B is a conceptual diagram illustrating a second exemplary embodiment of a beam management method after beam failure reporting.

Referring to FIG. 8B, the terminal 820 may fall back to the last beam selected based on the reference signals for measurement. Specifically, the terminal 820 may fall back to the last beam selected based on the reference signals for measurement in the T1 period, and communicate with the base station 810 through the beam. Thereafter, the terminal 820 may select a new beam based on a response of the base station 810, as described above.

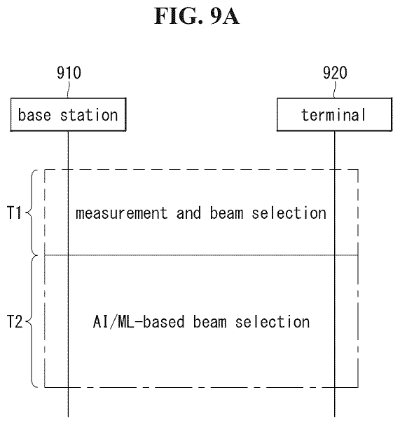

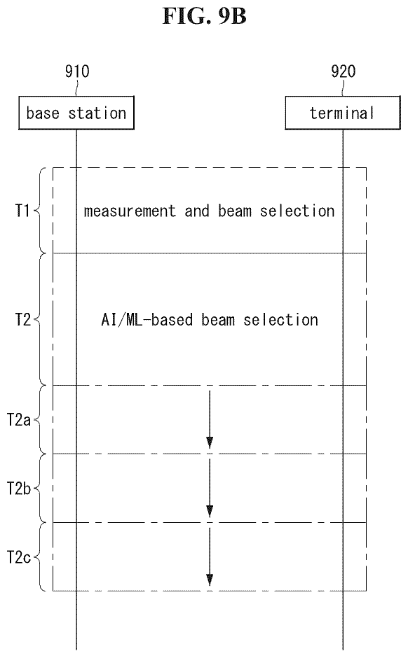

FIG. 9A is a conceptual diagram illustrating a first exemplary embodiment of a signaling method for the T1 period and the T2 period.

Referring to FIG. 9A, the T1 period may be a period for measurement or beam selection, and the T2 period may be a period for beam selection using an AI/ML model, as described above. Here, a base station may set a first timer for the T1 period or a second timer for the T2 period to a terminal 920 through signaling. Here, the first timer for the T1 period or the second timer for the T2 period may be configured to the terminal by the base station through an RRC signal as a cell-specific or beam-specific signal. The first timer for the T1 period or the second timer for the T2 period may be updated in the terminal by the base station through a MAC CE or DCI as a terminal-specific (i.e., UE-specific) signal. As a specific example, the base station 910 may set the first timer for the T1 period and the second timer for the T2 period in the terminal 920 through an RRC signal. In this case, the base station may indicate the terminal to activate/deactivate the first timer for the T1 period and the second timer for the T2 period through a MAC CE or DCI. As an example, the base station may set the first timer for the T1 period and the second timer for the T2 period in the terminal 920 equipped with the AI/ML function through RRC signaling. In this case, the base station 910 may indicate the terminal 920 to activate the first timer for the T1 period and the second timer for the T2 period through a MAC CE or DCI. Accordingly, the first timer for the T1 period and the second timer for the T2 period may be activated in the base station and the terminal. In this case, the base station and the terminal may perform measurement or beam selection in the T1 period. In addition, the base station and the terminal may select beam(s) in the T2 period through the AI/ML model. On the other hand, the base station 910 may indicate the terminal 920 to deactivate the first timer for the T1 period and the second timer for the T2 period through a MAC CE or DCI. Accordingly, the first timer for the T1 period and the second timer for the T2 period may be deactivated in the base station and the terminal. When the first timer for the T1 period and the second timer for the T2 period are deactivated as described above, the second timer for the T2 period may not be set in the terminal. Accordingly, the terminal may only set a timer for a period for measurement or beam selection as in the existing scheme, but may not be limited to the corresponding exemplary embodiment.

As another example, configuration information of the first timer for the T1 period and the second timer for the T2 period may be transmitted from the base station 910 to the terminal 920 through at least one an RRC signal, MAC-CE, or DCI as a UE-specific signal, and may not be limited to a specific exemplary embodiment.

As another example, the base station may set the first timer for the T1 period and the second timer for the T2 period in the terminal 920. In this case, a method for indicating the T1 period and the T2 period may be required. Here, the T1 period and the T2 period may be indicated based on a starting or ending point, and may be configured based on at least one unit among symbol, slot, millisecond, or second. In addition, the T1 period and the T2 period may be configured based on at least one unit among symbol, slot, millisecond, or second as a duration (window) value. As a more specific example, a starting point and a duration (window) value for each of the T1 period and the T2 period may be indicated by the base station to the terminal so as to be configured in the terminal 920, and the above-described operation may be performed based thereon.

FIG. 9B is a conceptual diagram illustrating a second exemplary embodiment of a signaling method for the T1 period and the T2 period.

Referring to FIG. 9B, a beam failure may not occur during the T2 period. In this case, the T2 period may be extended. In other words, after the T2 period ends, a starting point of the next T1 period may be postponed. Here, if a beam failure does not occur during the T2 period, the T2 period may be extended by T2a.

In addition, a beam failure may not occur during a period including the T2 period and T2a period. In this case, the T2 period may be further extended by a sum of a T2b period and the T2a period.

In addition, a beam failure may not occur during a period including the T2 period, T2a period, and T2b period. In this case, the T2 period may be further extended by a sum of a T2c period, the T2 period, T2a period, and T2b period. The above-described operation may be performed iteratively up to N times. Here, N may be a natural number. Here, the above-described extension operation may be indicated by the base station 910 to the terminal 920 through RRC signaling, MAC CE, or DCI, and is not limited to a specific exemplary embodiment.

As another example, a case where there is an indication from the base station 910 to extend the T2 period may be considered. For example, within the T2 period, the base station 910 may transmit a plurality of beam sets (e.g., beam set M_A) for aperiodic measurement to the terminal, and indicate the terminal 920 to perform measurement. In this case, the terminal 920 may perform measurement based on the corresponding beam sets (e.g., beam set M_A) and report a measurement result to the base station 910. Then, the base station 910 may indicate the terminal to extend the T2 period through a MAC CE or DCI. Based on the indication, the T2 period may be extended. As another example, the base station 910 may indicate the terminal 920 to extend the T2 period regardless of the measurement procedure described above, and may not be limited to a specific exemplary embodiment.

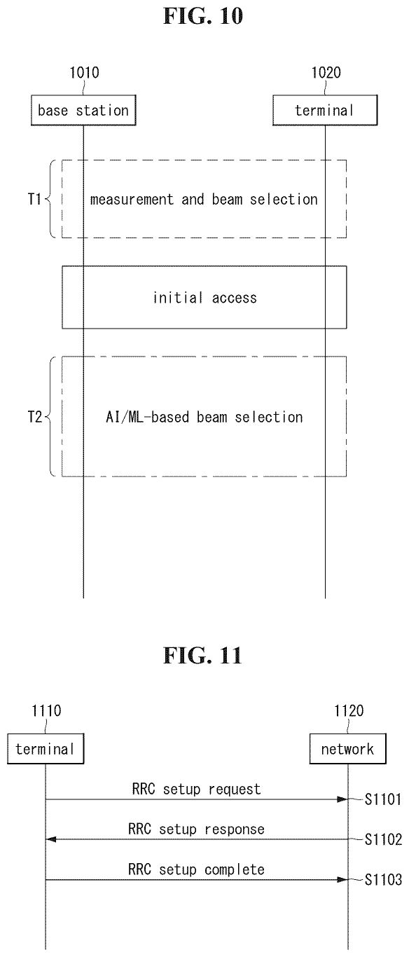

FIG. 10 is a conceptual diagram illustrating a first exemplary embodiment of a configuration method for the T1 period and the T2 period.

Referring to FIG. 10, during the T1 period, a terminal 1020 may select beam(s) by measuring reference signals before connecting to a base station 1010. That is, the terminal 1020 may initially connect to the base station 1010. In this case, since the terminal 1020 is not able to recognize information related to the base station 1010, the terminal 1020 may select beam(s) through measurement on the reference signals.

Thereafter, the terminal 1020 may be connected to the base station 1020 by performing initial access. After the terminal 1020 connects to the base station 1010, the terminal can recognize information on a previous beam, and the terminal 1020 may obtain information related to the base station 1010. Here, if the terminal 1020 is equipped with AI/ML functions, the terminal 1020 may perform AI/ML-based beam selection during the T2 period through the information on the previous beam and the information related to the base station 1010 after connecting to the base station 1010. For example, when the above-described beam failure occurs, the base station 1010 may transmit reference signals to the terminal 1020 based on the beam failure, and beam selection may be performed based on measurement. As another example, the terminal 1020 may perform beam selection based on AI/ML and may perform measurement-based beam selection based on an aperiodic base station request. As another example, the terminal 1020 may perform AI/ML model-based beam selection, and may perform measurement-based beam selection according to a long periodicity of reference signal transmission, but is not limited to a specific exemplary embodiment.

FIG. 11 is a sequence chart illustrating a first exemplary embodiment of a method for establishing an RRC connection between a terminal and a network.

Referring to FIG. 11, a terminal 1110 may transmit an RRC setup request to a network 1120 (S1101). Then, the network 1120 may receive the RRC setup request from the terminal 1110, and the network 1120 may transmit an RRC setup response to the terminal 1110 (S1102). Then, the terminal 1110 may receive the RRC setup response from the network 1120 and complete RRC setup. Thereafter, the terminal 1110 may transmit an RRC setup complete message to the network 1120 (S1103). Then, the network 1120 may receive the RRC setup complete message from the terminal 1110. In this case, as an example, an indication as to whether AI/ML can be utilized may be required in the above-described operations. More specifically, availability of AI/ML may differ for each terminal considering operations of a legacy terminal that does not support AI/ML functions.

In addition, the terminal may require communication without performing AI/ML functions. In such cases, an indication on whether AI/ML can be utilized may be required based thereon. Here, as an example, whether AI/ML can be utilized may be indicated through RRC. In other words, whether AI/ML can be utilized may be indicated through RRC signaling. As a more specific example, the base station may indicate ‘AI/ML_beam_enable=ON’ to the terminal through RRC signaling. In this case, the terminal may utilize AI/ML functions. On the other hand, the base station may indicate ‘AI/ML_beam_enable=OFF’ to the terminal. In this case, the terminal may not utilize AI/ML functions. However, this is merely one example, and the present disclosure is not limited to the above-described exemplary embodiment.

In this case, when AI/ML utilization is possible, a beam management procedure utilizing AI/ML functions as described above may be supported between the base station and the terminal. Here, the above-described procedure may be applied to all terminals. Alternatively, the above-described procedure may be applied only to terminals equipped with AI/ML functions, and they may not be limited to a specific exemplary embodiment.

In addition, whether AI/ML utilization is possible may be configured using at least one of a cell-specific parameter, a beam-specific parameter, or a terminal-specific parameter, but the present disclosure is not limited to a specific exemplary embodiment.

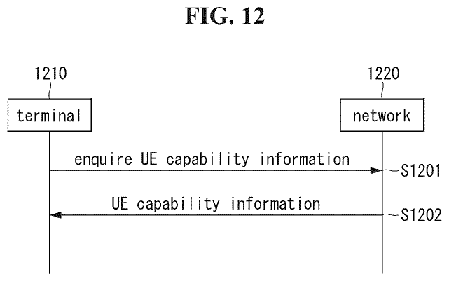

FIG. 12 is a sequence chart illustrating a first exemplary embodiment of a method for transmitting UE capability information.

Referring to FIG. 12, a network 1220 may transmit a UE capability enquiry signal to a terminal 1210 to enquire capabilities of the terminal (S1201). Then, the terminal 1210 may receive the UE capability enquiry signal from the network 1220, and the terminal 1210 may report UE capability information to the network 1220 (S1202). Here, the capabilities of the terminal may include a capability to utilize the AI/ML functions described above. That is, the terminal equipped with the AI/ML functions may perform the above-described operations, and the terminal 1210 may include the corresponding information in the UE capability information, and report it to the network 1220. As a specific example, the terminal may report that it has the AI/ML functions by transmitting an RRC parameter of ‘AI/ML_UE_enable=ON’ to the network. Alternatively, the terminal may report to the network that it does not have the AI/ML functions by transmitting an RRC parameter of ‘AI/ML_UE_enable=OFF’ to the network.

Here, as an example, the above-described AI/ML-based beam management procedure may be performed when beam management using the AI/ML functions is signaled as being possible with the RRC parameter (‘AI/ML_beam_enable=ON’), and the present disclosure is not limited to the specific exemplary embodiment.

Alternatively, as another example, the above-described AI/ML-based beam management procedure may be performed when beam management using the AI/ML functions is signaled as being possible with the RRC parameter (‘AI/ML_beam_enable=ON’) and the terminal is signaled as being equipped with AI/ML capability with the RRC parameter (‘AI/ML_UE_enable=ON’), and the present disclosure is not limited to the specific exemplary embodiment.

Meanwhile, the base station or terminal may perform beam management using AI/ML during the T2 period after performing training during the T1 period (T1, 1), may determine whether to update trained values (result values or input values) for the previous T1 period (T1, 1) when performing training during the next T1 period (T1, 2), and may inform (indicate or report) this to each other.

Alternatively, the base station or terminal may perform beam management using AI/ML during the T2 period after performing training during the T1 period (T1, 1), may determine whether to newly perform training by ignoring values trained during the previous T1 period (T1, 1) when performing training during the next T1 period (T1, 2), and may inform (indicate or report) this to each other.

In addition, the base station or terminal may update the AI/ML model by excluding values trained during a specific period. For example, the base station or terminal may update the AI/ML module based on values of the period (T1, 1) during the period (T1, 3) after the period (T1, 1) and the period (T1, 2) by excluding values trained during the period (T1, 2).

As an exemplary case in which values trained during a specific period or previous period are excluded, if a beam failure occurs during a T2 period (e.g., period T2, 2) as a result of operating based on values trained in a period (e.g., period (T1, 2), the base station or terminal may exclude the values trained during the period (T2, 2).

Alternatively, as an exemplary case in which values trained during a specific period or previous period are excluded, if a reference value (e.g., beam failure probability) of result values of AI/ML as a result of operating during a T2 period (e.g., period (T2, 2) based on values trained in a period (e.g., period T1, 2), the base station or terminal may exclude the values trained during the period (T1, 2).

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a terminal, comprising:
receiving reference signals from a base station through primary candidate beams;
generating measurement information for the reference signals of the primary candidate beams;
selecting N secondary candidate beams using an artificial intelligence (AI)/machine learning (ML) model based on the measurement information for the primary candidate beams; and
transmitting information on the selected N secondary candidate beams to the base station,
wherein N is a positive integer.

2. The method according to claim 1, wherein the measurement information for the primary candidate beams includes at least one of a reference signal received power (RSRP), a reference signal received quality (RSRQ), a signal to interference-plus-noise ratio (SINR), or a signal noise ratio (SNR) for each of the reference signals of the primary candidate beams.

3. The method according to claim 1, wherein each of the reference signals is one of a synchronization signal block (SSB), a channel state information-reference signal (CSI-RS), or a positioning RS (PRS).

4. The method according to claim 1, wherein the terminal performs the selecting of the N secondary candidate beams using the AI/ML model based on the measurement information for the primary candidate beams, by additionally using a location and movement path information of the terminal.

5. The method according to claim 4, wherein the location and the movement path information of the terminal include at least one of the location, a trajectory, an angle of arrival (AOA), or an angle of departure (AOD).

6. The method according to claim 1, further comprising, before the receiving of the reference signals from the base station through the primary candidate beams,
receiving reference signals from the base station through beams;
obtaining received signal strengths for the reference signals of the beams;
selecting the primary candidate beams based on the received signal strengths of the beams; and
transmitting information on the selected primary candidate beams to the base station.

7. The method according to claim 1, further comprising:
receiving reference signals from the base station through tertiary candidate beams selected from among the secondary candidate beams;
generating measurement information for the reference signals of the tertiary candidate beams;
selecting M quaternary candidate beams using the AI/ML model based on the measurement information for the tertiary candidate beams; and
transmitting information on the selected M quaternary candidate beams to the base station,
wherein M is a positive integer.

8. The method according to claim 1, further comprising: receiving configuration information on the reference signals for the primary candidate beams from the base station through radio resource control (RRC) signaling, wherein the terminal receives some reference signals using the configuration information in the receiving of the reference signals from the base station through the primary candidate beams.

9. The method according to claim 8, wherein the configuration information on the reference signals for the primary candidate beams includes a reference signal type and a reference signal periodicity.

10. The method according to claim 1, further comprising:
detecting a beam failure;
selecting alternative candidate beams using the AI/ML model based on the measurement information for the primary candidate beams; and
transmitting a beam failure report including information on the alternative candidate beams to the base station.

11. The method according to claim 10, further comprising: receiving information on a resource for the beam failure report from the base station, wherein the terminal transmits the beam failure report including information on the alternative candidate beams to the base station using the resource for the beam failure report.

12. A method of a base station, comprising
transmitting reference signals to a terminal through primary candidate beams;
receiving information on secondary candidate beams selected by the terminal based on measurement information for the primary candidate beams;
selecting tertiary candidate beams using an AI/ML model based on the information on the secondary candidate beams; and
transmitting reference signals to the terminal through the tertiary candidate beams.

13. The method according to claim 12, wherein the base station performs the selecting of the tertiary candidate beams using the AI/ML model based on the information on the secondary candidate beams, by additionally using at least one of interference information, resource allocation information, or neighboring base station information.

14. The method according to claim 12, further comprising, before the transmitting of the reference signals to the terminal through the primary candidate beams,
transmitting reference signals to the terminal using beams; and
receiving, from the terminal, information for the primary candidate beams selected based on received signal strengths of the beams.

15. The method according to claim 12, further comprising:
transmitting information on a resource for a beam failure report to the terminal; and
receiving the beam failure report including information on alternative candidate beams from the terminal using the resource for the beam failure report.

16. The method according to claim 15, further comprising:
selecting quaternary candidate beams using the AI/ML model based on information on the alternative candidate beams; and
transmitting information on the quaternary candidate beams to the terminal.

17. A terminal comprising a processor,
wherein the processor causes the terminal to perform:
receiving reference signals from a base station through primary candidate beams;
generating measurement information for the reference signals of the primary candidate beams;
selecting N secondary candidate beams using an artificial intelligence (AI)/machine learning (ML) model based on the measurement information for the primary candidate beams; and
transmitting information on the selected N secondary candidate beams to the base station,
wherein N is a positive integer.

18. The terminal according to claim 17, wherein the processor further causes the terminal to perform: before the receiving of the reference signals from the base station through the primary candidate beams,
receiving reference signals from the base station through beams;
obtaining received signal strengths for the reference signals of the beams;
selecting the primary candidate beams based on the received signal strengths of the beams; and
transmitting information on the selected primary candidate beams to the base station.

19. The terminal according to claim 17, wherein the processor further causes the terminal to perform:
detecting a beam failure;
selecting alternative candidate beams using the AI/ML model based on the measurement information for the primary candidate beams; and
transmitting a beam failure report including information on the alternative candidate beams to the base station.

20. The terminal according to claim 19, wherein the processor further causes the terminal to perform: receiving information on a resource for the beam failure report from the base station, wherein the terminal transmits the beam failure report including information on the alternative candidate beams to the base station using the resource for the beam failure report.
